(19) United States
(12) Patent Application Publication
(10) Pub. No.: US 2004/0151399 A1
(43) Pub. Date: Aug. 5, 2004

(54) Positioning images in association with templates

(76) Inventors: Vincent C. Skurdal, Boise, ID (US); Mark L. Brown, Boise, ID (US); Shane T. Gehring, Meridian, ID (US)

Correspondence Address: HEWLETT-PACKARD COMPANY, Intellectual Property Administration, P.O. Box 272400, Fort Collins, CO, 80527-2400, US

(21) Appl. No.: 10/354,370

(22) Filed: Jan. 30, 2003

(51) Int. Cl. G06K 9/40

(52) U.S. Cl. 382/266

(57) ABSTRACT

Systems, methods, and devices for positioning images in association with templates are provided. A method includes providing one or more images and one or more templates, having one or more image positions. The method includes defining an association between at least one image position and at least one image on one or more print media. The method further includes scanning the one or more print media having at least one defined association and configuring at least one image into at least one image position according to at least one defined association.

When an image, such as a photograph or painting, is displayed, oftentimes a material is used to create a border surrounding an opening through which an image can been seen. This bordering material is generally referred to as a mat. Mats are often utilized to enhance presentation by adding a distinctive shape or color to the area surrounding the image.

A mat is often a single piece of material that is placed between an image and the glass or other transparent material of a picture frame. However, mats are also utilized alone or with a backing board to provide a frame around the image when viewed. For example, an image can be placed against a mat material such that the image can be seen through an opening formed in the mat. A backing board can also be utilized to keep the image pressed against the surface of the mat.

Mats include borders of single images and also include collage configurations wherein several images are surrounded by a border of mat material. The use of a collage style mat, having multiple openings formed in a single piece of mat material, can individually highlight a number of images within a single framed display. Mats having multiple openings are often used to showcase multiple images having a similar theme, such as images from a vacation, images of children in a family, a picture of a team and one or more pictures of players on the team, and the like.

In the past, it was necessary to physically position and align one or more images (with each image being on a separate piece of photographic or print media) such that they could be viewed through the one or more openings in the mat. However, the alignment of the images with respect to each other and with respect to the sides of the mat openings was difficult, since each image was on a different piece of material.

Additionally, in some cases the images had to be formatted (i.e. shaped, scaled, cropped, etc.) to fit into the openings provided in the mat. This required the openings and the images to be carefully measured to ensure that the images would properly fit the openings of the mat.

More recently, with the advent of computers, it has become possible to arrange a plurality of images for printing on a single sheet of print media prior to actually printing the images on the media. For example, the Microsoft PictureIt™, version 1.0 includes an image input screen (“get it” screen) that provides multiple reduced resolution, or “thumbnail”, images. However, the thumbnail images must be dragged and dropped one at a time from the get it screen to a holding area.

The user then must exit the image input mode and switch to a print layout mode within a “share it” screen. In this mode, the user must drag and drop the first image from the holding area into the print layout screen. The user must then manually resize, rotate (if required), and position the first image, for example, in the upper left of the screen. Next, the user selects the second image and manually attempts to properly size and position this image, for example, in the upper right of the screen. Finally, after all images have been manually resized and positioned, the composite image is ready to print. Thus, creating a page with properly sized and positioned images requires the user to perform various manual operations with an appreciation or awareness of an intended mat configuration.

Additionally, computer programs have also been developed that have a plurality of templates, that allow a user to position a plurality of images in predefined positions on a sheet of print media. Each template has the positions for several images predefined thereon. In this way, a user can select an image and place the selected image in a predefined location on the template and then, once all of the images are selected, the images can be printed on a sheet of print media. However, even with these developments, these programs do not allow a user to configure images on a template of their choice that is outside of the limited set of predefined templates provided with a particular computer program. For example, a user may purchase a mat in which there is no suitable predefined template. Additionally, a user may decide to create their own mat and, therefore, it would be difficult, if not impossible, to match the created mat with a proper template.

Moreover, such predefined mat template programs require a display that is capable of showing the images and a mat template thereon in order to properly select and align the images. A display is also necessary in order to manually manipulate the images, for example, by adjusting the scale, changing the shape, rotating, cropping, and the like, if such adjustment is desired. Additionally, various approaches require the use of a PC host. The multiple approaches described above do not afford a level of user-friendliness desired for layperson photo takers to effectively utilize mat materials with their images.

### BRIEF DESCRIPTION OF THE DRAWINGS

FIG. 1 is a system embodiment according to the teachings of the present invention.

FIG. 2A is a multi-function printing device embodiment according to the teaching of the present invention.

FIG. 2B is a block diagram illustrating components of a multi-function printing device embodiment according to the teachings of the present invention.

FIG. 3A is a proof sheet embodiment according to the teachings of the present invention.

FIG. 3B is another proof sheet embodiment according to the teachings of the present invention.

FIG. 3C is another proof sheet embodiment according to the teachings of the present invention.

FIG. 3D is a proof sheet illustrating some additional features that are provided in various embodiments according to the teachings of the invention.

FIG. 4A is another embodiment of a proof sheet according to the teachings of the present invention.

FIG. 4B is another embodiment of a proof sheet according to the teachings of the present invention.

FIG. 5A is another embodiment of a proof sheet according to the teachings of the present invention.

FIG. 5B is another embodiment of a proof sheet according to the teachings of the present invention.

FIG. 6A is another embodiment of a proof sheet according to the teachings of the present invention.

FIG. 6B is another embodiment of a proof sheet according to the teachings of the present invention.

FIG. 7 is a block diagram illustrating a method embodiment according to the teachings of the invention.

FIG. 8 is a block diagram illustrating another method embodiment according to the teachings of the invention.

FIG. 9 is a block diagram illustrating another method embodiment according to the teachings of the invention.

### DETAILED DESCRIPTION

The present invention provides techniques for positioning images and includes systems and devices for positioning images and for printing images on print media. The present invention includes embodiments that can be utilized with or without a display that is capable of showing the images and/or one or more mat templates.

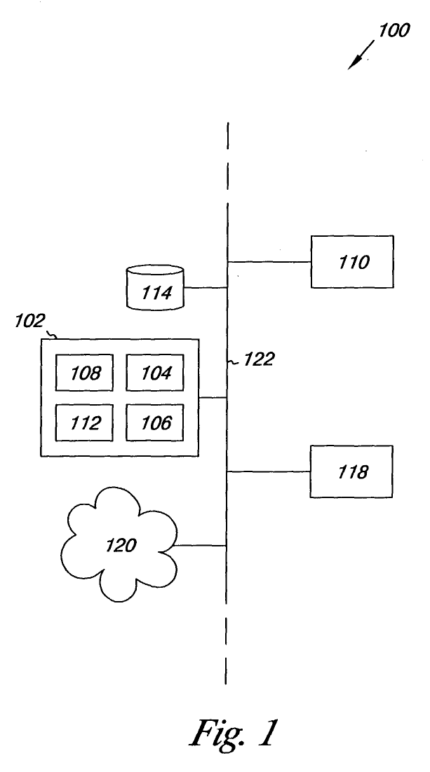

FIG. 1 illustrates a system environment 100 according to various embodiments of the present invention. As shown in FIG. 1, the system includes a printing device 102 and a scanning device (defined in the embodiment shown as a peripheral device 118). With regard to the various embodiments of the invention that can be utilized with a system such as the system 100 shown in FIG. 1, the printing device 102 is operable to print a proof sheet having one or more images and/or one or more mat templates thereon. In various embodiments of the invention, the scanning device peripheral 1118 is operable to receive scan data from a proof sheet having at least one association between an image and an image position of a template.

The system 100 is operable to receive scan data from a proof sheet and interpret the data to format an image, for example by positioning the image in an associated image position. The system 100 is also operable to receive additional formatting instructions in the scan data and interpret the data to further format an image, for example by rotating an image. The system 100 can include software and/or application modules thereon for receiving and interpreting data in order to achieve the positioning and/or formatting functions. As one of ordinary skill in the art will appreciate, the software and/or application modules can be located on any device that is directly or indirectly connected to the printing device 102 and the scanning device peripheral 118 within the system 100.

In various embodiments, including the embodiment shown in FIG. 1, the printing device 102 can include one or more processors 104 and one or more memory devices 106. The one or more processors 104 are operable on computer readable instructions, along with or in conjunction with application modules, for interpreting image and/or template data and/or for interpreting formatting instructions. In the various embodiments, the one or more memory devices 106, include memory devices 106 on which data, including computer readable instructions, images and/or template data, and other information of the like can reside.

In the embodiment shown in FIG. 1, the printing device 102 can include a printing device driver 108 and a print engine 112. In various embodiments of FIG. 1, additional printing device drivers can be located off the printing device, for example, on the remote device 110. Such printing device drivers can be an alternative to the printing device driver 108 located on the printing device 102 or provided in addition to the printing device driver 108. As one of ordinary skill in the art will understand, a printing device driver 108 is operable to create a computer readable instruction set for a print job utilized for rendering an image by the print engine 112. Printing device driver 108 includes any printing device driver suitable for carrying out various aspects of the present invention. That is, the printing device driver can take data from one or more software applications and transform the data into a print job.

As shown in the embodiment of FIG. 1, printing device 102 can be networked to one or more remote devices 110 over a number of data links, shown as 122. As one of ordinary skill in the art will appreciate upon reading this disclosure, the number of data links 122 can include one or more physical and one or more wireless connections, and any combination thereof, as part of a network. That is, the printing device 102 and the one or more remote devices 110 can be directly connected and can be connected as part of a wider network having a plurality of data links 122.

In various embodiments, a remote device 110 can include a device having a display such as a desktop computer, laptop computer, a workstation, hand held device, or other device as the same will be known and understood by one of ordinary skill in the art. The remote device 110 can also include one or more processors and/or application modules suitable for running software and can include one or more memory devices thereon.

As shown in the embodiment of FIG. 1, a system 100 can include one or more networked storage devices 114, e.g. remote storage database and the like, networked to the system. Likewise, the system 100 can include one or more peripheral devices 118, and one or more Internet connections 120, distributed within the network.

As one of ordinary skill in the art will appreciate upon reading this disclosure, the network described herein can include any number of network types including, but not limited to a Local Area Network (LAN), a Wide Area Network (WAN), Personal Area Network (PAN), and the like. And, as stated above, data links 122 within such networks can include any combination of direct or indirect wired and/or wireless connections, including but not limited to electrical, optical, and RF connections.

As one of ordinary skill in the art will appreciate upon reading this disclosure, memory, such as memory 106 and memory 114, can be distributed anywhere throughout a networked system. Memory, as the same is used herein, can include any suitable memory for implementing the various embodiments of the invention. Thus, memory and memory devices include fixed memory, such as a hard drive, a memory chip on a printed circuit board, a portable memory, such as a memory card, memory stick, flash card and the like. One of ordinary skill in the art will appreciate the manner in which software, e.g. computer readable instructions, can be stored on such memory medium. Other memory mediums include CDs, DVDs, and floppy disks. The invention, however, is not limited to any particular type of memory medium. And, the invention is not limited to where within a device or networked system a set of computer instructions reside for use in implementing the various embodiments of invention.

As stated above, the system embodiment 100 of FIG. 1 includes one or more peripheral devices 118. Peripheral devices can include any number of peripheral devices in addition to those already mentioned herein. Examples of peripheral devices include, but are not limited to, scanning devices, faxing devices, copying devices, modem devices, and the like. In the embodiment of FIG. 1, peripheral device 118 includes a scanning device.

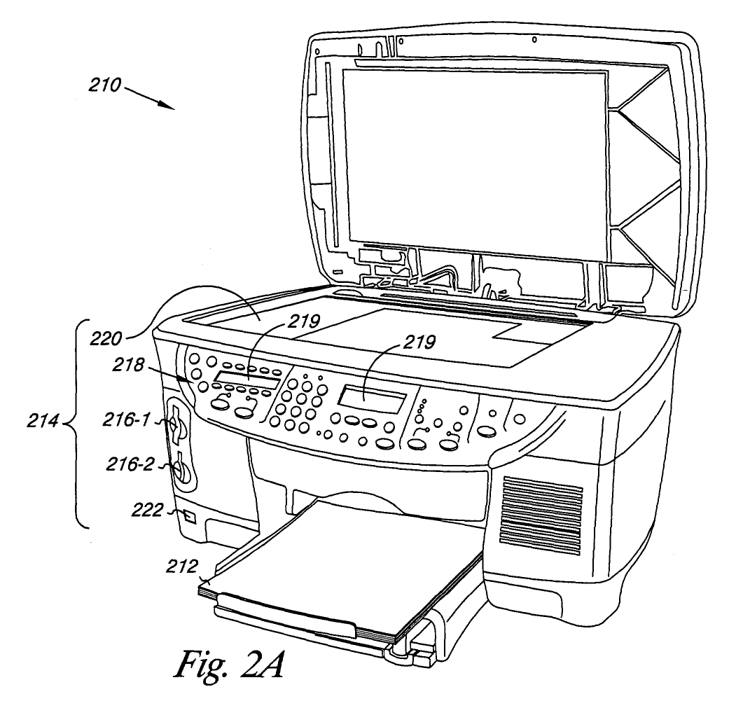

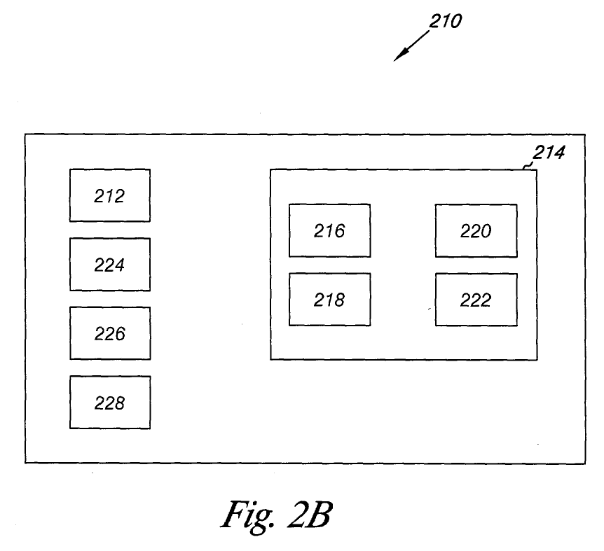

The printing device 102 and the one or more peripheral devices, such as scanning device 118, can be individual devices. However, as one of ordinary skill in the art will appreciate upon reading this disclosure, the printing device 102 and the one or more peripheral devices, such as scanning device 118, can be combined into a multi-function device. For example, Hewlett Packard produces several devices that provide printing, copying, and scanning. Additionally, some of these multi-function devices also include faxing capabilities. These types of devices are generally referred to as PCS (Printing/Copying/Scanning) devices or as All-in-One (AiO) devices. One example of such a multi-function device is illustrated in FIGS. 2A and 2B.

FIG. 2A provides a perspective illustration of a multi-function device 210, suitable for use with various embodiments of the present invention. In this embodiment, the multi-function device 210, is a multi-function printing device and, as with devices having just print functionality, the multi-function device 210 includes a print media input/output 212, one or more data input mechanisms 214, and a print mechanism (internal to FIG. 2A), among other things. The device 210 embodiment of FIG. 2A illustrates one or more displays 219 operable as a user interface.

The device 210 embodiment of FIG. 2A further illustrates one or more memory media slots 216-1 and 216-2, a keypad 218, a scan/copy mechanism 220, and a data port 222. As one of ordinary skill in the art will appreciate, the multi-function device embodiment of FIG. 2A is thus operable to obtain data, of any type, from any number of sources. As one of ordinary skill in the art will appreciate upon reading this disclosure, data in the various embodiments includes information such as user commands, image data, scan data, print data, proof sheet data, and template data, among others.

As one of ordinary skill in the art will appreciate upon reading this disclosure, the multi-function device 210 embodiment of FIG. 2A can be utilized as the printing device 102 in system 100 of FIG. 1. However, additionally, the multi-function device 210 embodiment of FIG. 2A can function as a stand alone unit operable to implement the various embodiments of the present invention.

FIG. 2B provides a block diagram embodiment of the components and/or circuitry associated with a multi-function device such as the multi-function device 210 shown in FIG. 2A. In the embodiment of FIG. 2B, the device 210 includes a print media input/output component 212, a print mechanism component 224, and several types of data input mechanism components 214 such as one or more memory media slots 216, a keypad 218, a scanning/printing mechanism 220, and a data port 222. As noted above, the multi-function device 210 includes one or more processors and/or application modules 228 suitable for operating on software and computer executable instructions. In the embodiment of FIG. 2B, the multi-function device 210 is further illustrated having one or more memory devices 226 as the same have been described in detail herein.

It is noted that a multi-function device or system, such as device 210 of FIG. 2A or system 100 of FIG. 1, can provide for the creation of a proof sheet. That is, a proof sheet can be printed by a printing device such as printing device 102 of FIG. 1 and a proof sheet can be printed by a multi-function device such as multi-function device 210 of FIG. 2A. In various embodiments of the invention, the proof sheet includes a device readable medium such that the selections, made on the proof sheet can be received, interpreted, integrated, utilized, and operated upon. Various embodiments for selections on a proof sheet are discussed in more detail below.

As stated herein, various embodiments of the invention can be performed by software, application modules, and/or computer executable instructions, operable on the systems and devices described above or otherwise, for carrying out the aspects of the present invention. As one of ordinary skill in the art will appreciate upon reading this disclosure and practicing the invention, software, application modules, and/or computer executable instructions, suitable for carrying out the aspects of the present invention, can be resident in one or more devices or locations or in several and even many locations, such as in a distributed computing environment, throughout a system.

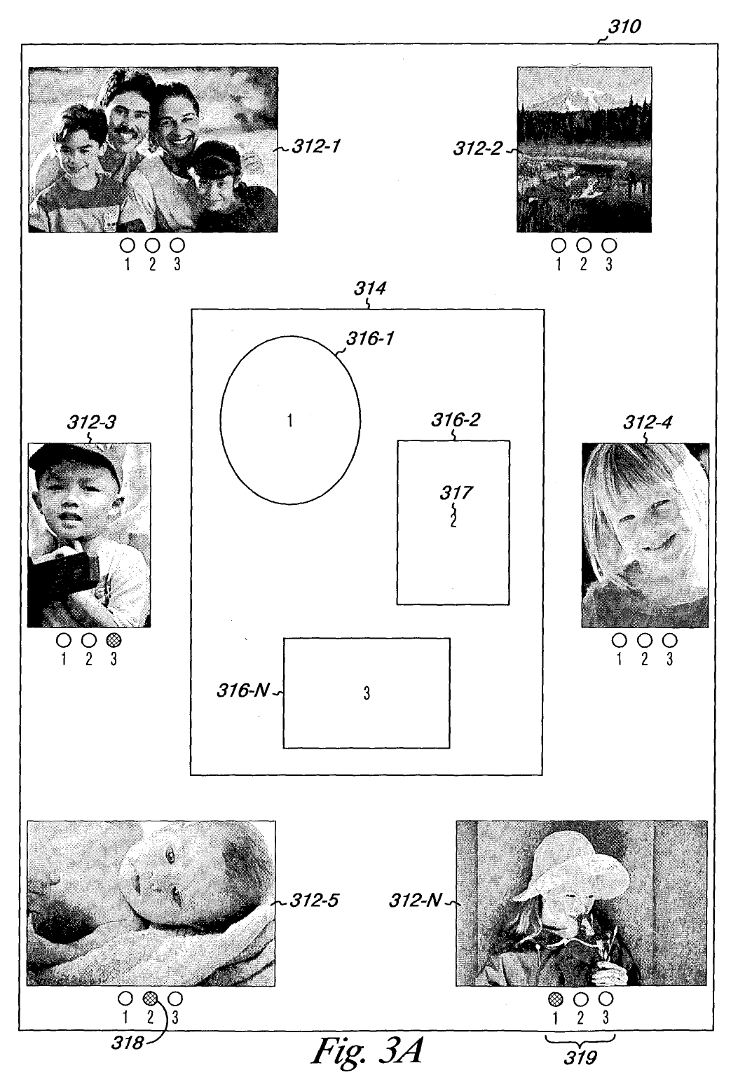

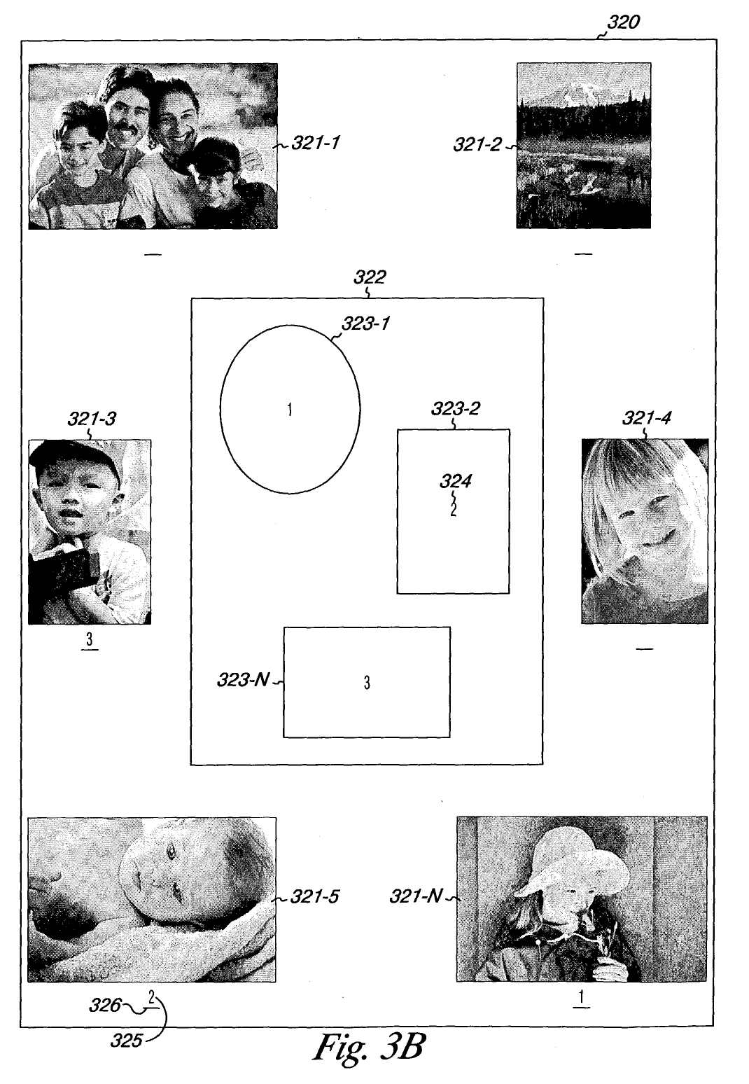

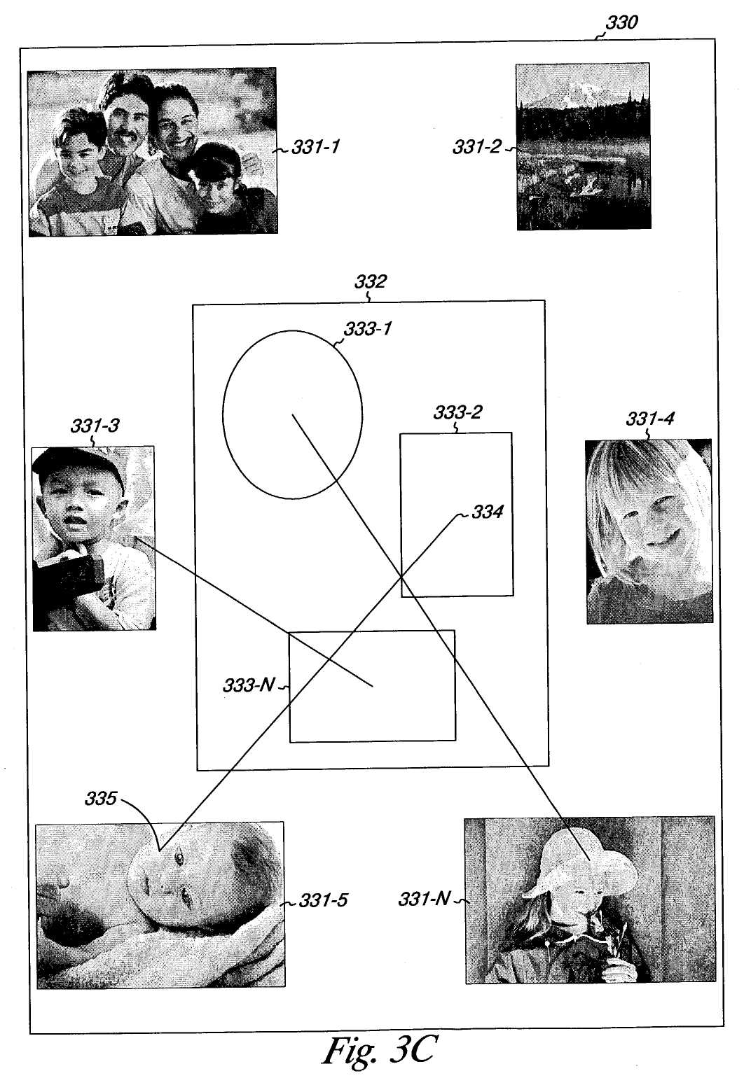

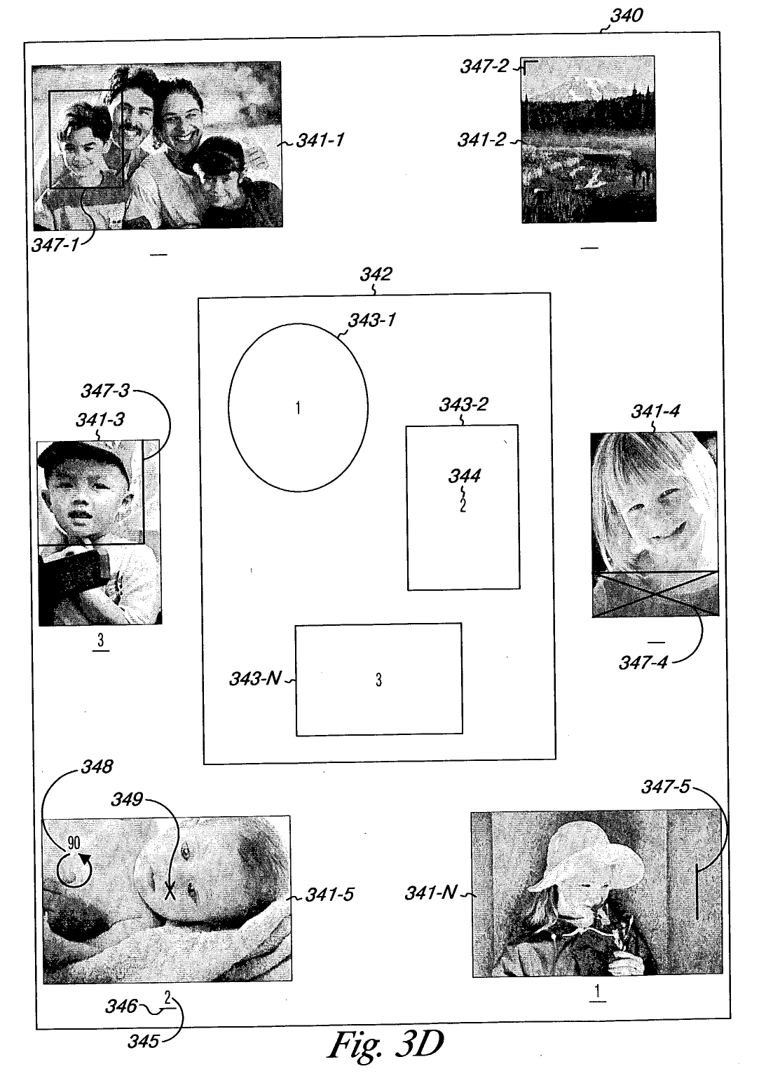

FIGS. 3A-3C illustrate a number of proof sheets which can be created, operated upon, and scanned in a device or system, such as device 210 of FIG. 2A or system 100 of FIG. 1, according to various embodiments of the present invention. FIGS. 3A-3C are used to illustrate various embodiments of the invention by which an association can be made between an image and a mat template on a proof sheet.

FIG. 3A illustrates an embodiment of a proof sheet 310 according to the teachings of the present invention. In the embodiment of FIG. 3A, a proof sheet 310 is illustrated having a plurality of images 312-1, . . . , 312-N thereon. Additionally, a representation of a mat is shown on the proof sheet 310 as a mat template 314 having one or more image positions 316-1, . . . , 316-N identified thereon. Each image position 316-1, . . . , 316-N on the mat template 314 has a different position identifier 317 assigned thereto.

As shown in the embodiment of FIG. 3A, a number of images, such as images 312-1, . . . , 312-N, can be provided as “thumbnails” on a periphery of the proof sheet 310. The invention, however, is not limited to the locations of images shown in FIG. 3A. And, as one of ordinary skill in the art will appreciate upon reading this disclosure, many images 312-1, . . . , 312-N, can be provided as thumbnails or otherwise on the a proof sheet 310 in the various embodiments.

As those skilled in the art will appreciate upon reading this disclosure and practicing the invention, the images and the templates can come from any source. For example, the image and/or template data can be resident in memory within the printing device 102 or remote device 110, can be resident in a remote storage device 114, and can be accessed from an Internet or other network connection 120. Likewise, the image and/or template data can be contained on a removable memory source such as a memory card, memory stick, CD, DVD, floppy disk, or the like. Such a removable memory can be inserted into a memory media slot 216, such as that shown in FIG. 2A. Further, the image and/or template data can be resident on a peripheral device 118 such as the scanning device in FIG. 1. The various memory sources can provide a wide pool of images and templates to choose from. Indeed, in various embodiments of the present invention, the mat templates can be selected from the group; of a universal template pool, e.g. contained or provided to a device, one or more mat templates configured from scanning a template into a device, and/or one or more mat templates configured by accessing and/or referencing a list of manufacturer template reference numbers over a network. The invention is not so limited.

In the embodiment of FIG. 3A, each of the images 312-1, . . . , 312-N includes an association identifier 319. In the embodiment shown in FIG. 3A, each of the association identifiers 319 include a number of bubbles, such as bubble 318 identified in connection with image 312-5. In the embodiment of FIG. 3A, the number of bubbles provided as association identifiers 319 are each labeled with a number to correspond to the various position identifiers, e.g. 317. That is, in the embodiment of FIG. 3A, the labeled bubbles are used to associate one or more images 312-1, . . . , 312-N with one or more image positions 316-1, . . . , 316-N.

Hence, in the embodiment of FIG. 3A, image 312-5 illustrates bubble 318 labeled 2. In the embodiment of FIG. 3A, mat template 314 is provided with a position identifier 317 also labeled 2. By marking the bubble labeled 2, among the association identifiers 319 for image 312-5, image 312-5 is associated to image position 316-2 on mat template 314. As one of ordinary skill in the art will understand from the embodiment of FIG. 3A, other bubbles can be similarly marked to associate other images 312-1, . . . , 312-N to other image positions 316-1, . . . , 316-N on the mat template 314.

FIG. 3B illustrates another embodiment of a proof sheet 320 according to the teachings of the present invention. In the embodiment of FIG. 3B, the proof sheet 320 includes a number of images 321-1, . . . , 321-N and a template 322 having one or more image positions 323-1, . . . , 323-N and one or more position identifiers 324. However, in the embodiment of FIG. 3B, the proof sheet 320 includes one or more spaces 326 in which one or more association identifiers 325 can be provided. For example, with respect to image 321-5, an association identifier 325, in this case the number 2, has been provided in a space 326 to associate image 321-5 with an image position 323-2 having a position identifier 324 also labeled with the number 2. Thus, an association between image 321-5 and image position 323-2 is formed since the association identifier 325 and the position identifier 324 correspond.

FIG. 3C illustrates another embodiment of a proof sheet 330, according to the teachings of the present invention. In the embodiment of FIG. 3C, a line segment is drawn between an image position 333-1, . . . , 333-N and an image, selected from images 331-1, . . . , 331-N, to be placed therein. In this case, one end of the line segment serves as the position identifier 334 and the other end of the line segment serves as the association identifier 335 while the line segment itself creates the association. The line need not be continuous, but should be sufficiently continuous to identify an association between the opening and the image.

According to various embodiments of the present invention, a mat template that is reflective of the sizes, shapes, and positions of the one or more openings present on a physical mat can be provided to one or more proof sheets. As noted above, in some embodiments, a physical mat is scanned by a scanning device, and the data regarding the size, shape, and position of each opening is determined through the use of a software program to create the mat template which can be selectably provided to one or more proof sheets, e.g. chosen by a user.

Those skilled in the art will appreciate upon reading this disclosure and practicing the invention that any type of position, association, or template identifiers can be utilized. As those skilled in the art will appreciate, examples of types of identifiers that can be utilized include, but are not limited to, one or more symbols, letters, numbers, shapes, line segments, colors, and the like. Additionally, an association identifier can be placed anywhere suitable with respect to the image and the selection of an association identifier can take any suitable form. As shown in embodiments of FIGS. 3A-3C, various suitable forms include, but are not limited to, bubbles or boxes of any shape, line segments, space designated for receiving an association identifier, and the like. Furthermore, some suitable locations include, but are not limited to, proximate the image, on the image, and the like.

Once one or more associations have been created on a proof sheet, the proof sheet data can be entered into a system or device such as a multi-function device 210, as shown in FIG. 2A, or into a system 100, shown in FIG. 1. Software according to the teachings of the present invention is operable to extract information from the proof sheet, including position identifiers, association identifiers, template identifiers, and the like. The software can arrange one or more images to one or more image positions based on extracted information. The software can also perform other formatting functions in addition to positioning the one or more images to one or more image positions. The same is discussed in more detail below.

FIG. 3D is a proof sheet illustrating various additional ways in which the proof sheet can be utilized to aid in the formatting of images. The various embodiments shown in FIG. 3D provide a number of ways in which marks on a proof sheet can be utilized to identify how images can be positioned, cropped, rotated, centered, or further formatted. Those skilled in the art will appreciate upon reading this disclosure and practicing the invention that these features and other formatting functions can be useful for both printing images as well as storing images in memory for future use.

In the embodiment of FIG. 3D, image 341-1 is used to illustrate an embodiment in which an image is being cropped through the use of a shape 347-1, such as a box, placed around a desired area. The invention, however, is not constrained to the shape shown in the embodiment of FIG. 3D. Any shape can be utilized to define an area on an image.

In the embodiment of FIG. 3D, image 341-2 is used to illustrate an embodiment in which an image is cropped through the use of one or more corner marks 347-2 to define a desired area. Any suitable type of mark can be utilized to define the corners of the area on an image. For example, in the case shown, one or more L-shaped marks can be utilized to define the edges of a desired area, however, the invention is not so limited.

In the embodiment of FIG. 3D, image 341-3 is used to illustrate an embodiment in which an image is being cropped through the use of one or more line segments 347-3 defining a desired area. Any suitable type of mark can be utilized to define the edges of an area on an image, such as continuous lines, dots, dashes, and the like. For example, in the case shown, one or more connected line segments that terminate at the edge of an image can be utilized to define the edges of a desired area, however, the invention is not so limited.

In the embodiment of FIG. 3D, image 341-4 is used to illustrate an embodiment in which an image is being cropped through the use of one or more marks 347-4 defining an area on the image to be removed or not printed. Any suitable type of mark can be utilized to mark the area to be discarded or left unprinted, such as crossed lines, shading, parallel lines, and the like across the area. For example, in the case shown, a set of crossed lines can be utilized to define the edges of the desired area to be discarded or left unprinted, however, the invention is not so limited.

In the embodiment of FIG. 3D, image 341-5 is used to illustrate an embodiment in which an image is being formatted through the use of one or more marks 348 indicating certain formatting instructions. In this embodiment, for example, a counterclockwise symbol and the number 90 are coupled together to indicate that the image is to be rotated 90 degrees in the counterclockwise direction. One of ordinary skill in the art will appreciate that a number of other suitable marks can be provided directly to an image on a proof sheet to achieve certain formatting instructions. The scope of the present invention is intended to cover the same.

In the embodiment of FIG. 3D, image 341-5 is also used to illustrate an embodiment in which an image is being formatted through the use of another type of mark 349 indicating a certain formatting instruction. In this embodiment, for example, an X is provided on the image to indicate where the image is to be centered with respect to an opening on the mat. In the embodiment of FIG. 3D, an association between image 341-5 and image position 343-2 has been made by providing an association identifier 345 on line or space 346 which corresponds to position identifier 344. With the addition of marks 348 and 349, image 341-5 can be rotated 90 degrees counterclockwise and selectively centered.

In the embodiment of FIG. 3D, image 341-N is used to illustrate an embodiment in which an image is being formatted through use of a mark 347-5 to define a plurality of areas. Any suitable type of mark can be utilized to define the areas. For example, in the case shown, a line segment can be utilized to define the edge of a desired area or a location to split an image into two images, however, the invention is not so limited. The desired image can then automatically be selected or can be manually selected by one or more additional marks, such as the crossed lines shown at 347-4 of image 341-4. Additionally, the two image portions can each be selected for their own image positions by utilizing additional marks or association identifiers or can be saved as independent images.

Those skilled in the art will appreciate upon reading this disclosure and practicing the invention that instructions for any suitable type of formatting can be provided in a similar manner. As those skilled in the art will appreciate, examples of suitable types of formatting include, but are not limited to, cropping, scaling, rotating, flipping, centering, justifying, special effects to change the look of the image such as matte, glossy, invert, and the like, filtering, and shaping of the image, among others. Software according to the teachings of the present invention is operable to extract information, provided according to the embodiments described herein, from the proof sheet. The software is operable to associate a formatting instruction with an image and to then format and/or position the image according to the one or more instructions received.

Additionally, any number of suitable marks or indications can be utilized separately or in combination according to the embodiments of the present invention to identify a formatting instruction, including but not limited to, one or more letters, numbers, symbols, words, and the like. Those skilled in the art will also appreciate upon reading this disclosure and practicing the invention that the process of formatting can be accomplished automatically or manually, the invention is not so limited.

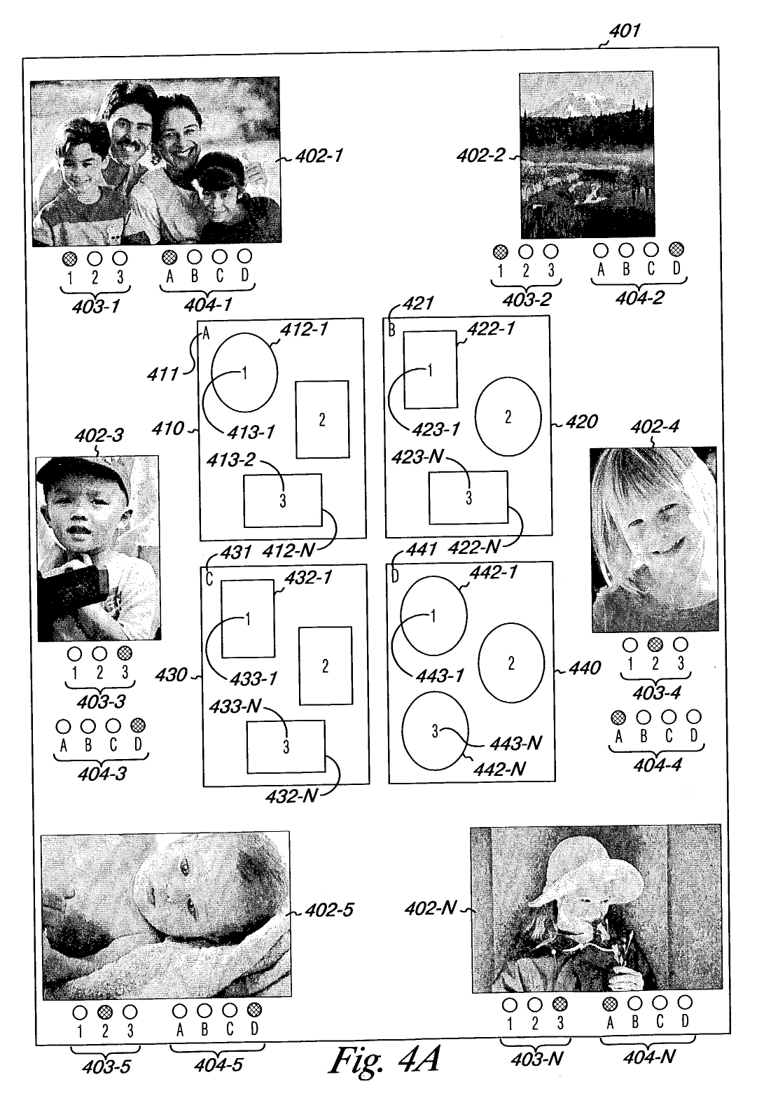

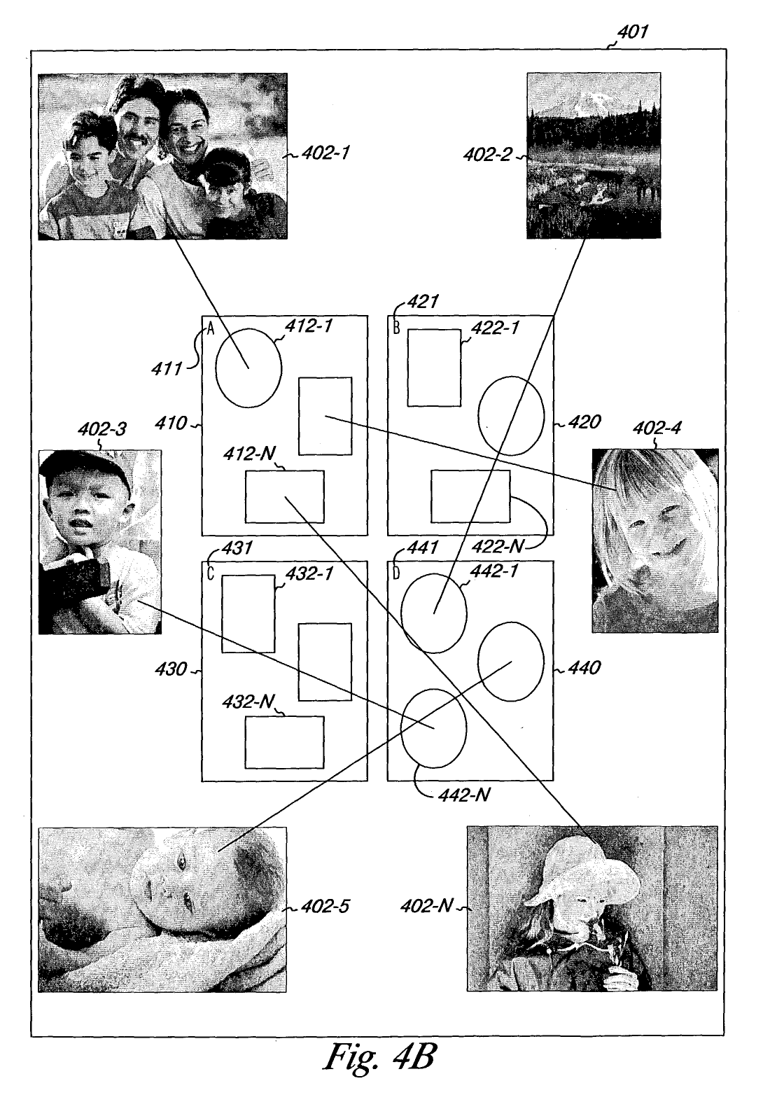

FIG. 4A illustrates another embodiment of a proof sheet 401 according to the teachings of the present invention. In the embodiment of FIG. 4A, a proof sheet 401 is shown having plurality of images 402-1, . . . , 402-N, as the same have been described in detail in connection with the above Figures. However, FIG. 4A also illustrates that the various embodiments of the present invention can include a proof sheet 401 having a plurality of mat templates thereon, e.g. 410, 420, 430, and 440. In the embodiment of FIG. 4A, each of the plurality of images 402-1, . . . , 402-N includes association identifiers 403-1, . . . , 403-N, as the same have been described herein in connection with the above Figures.

In the embodiment of FIG. 4A, each of the plurality of images 402-1, . . . , 402-N can further include a plurality of image template identifiers, illustrated as 404-1, . . . , 404-N. In the embodiment of FIG. 4A, each of the plurality of templates, e.g. 410, 420, 430, and 440, is provided with a mat template identifier, e.g. 411, 421, 431, and 441 respectively. As one of ordinary skill in the art will understand upon reading this disclosure, the mat template identifiers, e.g. 411, 421, 431, and 441 can include numbers, symbols, alpha-characters, e.g. A, B, C, and D as shown in the embodiment of FIG. 4A, and the like. Any form of identifier which can distinguish the plurality of templates, e.g. 410, 420, 430, and 440, is considered within the scope of the present invention.

As described in detail above, each of the plurality of templates, e.g. 410, 420, 430, and 440, can include a plurality of image positions or openings of any shape or form as the same have been described in detail in connection with the above Figures. In the embodiment of FIG. 4A, the plurality of image positions or openings, of any shape or form, are illustrated as 412-1, . . . , 412-N, 422-1, . . . , 422-N, 432-1, . . . , 432-N, and 442-1, . . . , 442-N respectively.

As one of ordinary skill in the art will appreciate upon reading this disclosure, each of the plurality of image positions or openings, 412-1, . . . , 412-N, 422-1, . . . , 422-N, 432-1, . . . , 432-N, and 442-1, . . . , 442-N, in each of the plurality of templates, e.g. 410, 420, 430, and 440, can include a plurality of position identifiers as the same have been described in detail herein. In the embodiment of FIG. 4A, the plurality of position identifiers are illustrated as 413-1, . . . , 413-N, 423-1, . . . , 423-N, 433-1, . . . , 433-N, and 443-1, . . . , 443-N respectively. Again, as one of ordinary skill in the art will appreciate upon reading this disclosure, the plurality of position identifiers, 413-1, . . . , 413-N, 423-1, . . . , 423-N, 433-1, . . . , 433-N, and 443-1, . . . , 443-N, can include numbers, (e.g. 1, 2, 3, etc. as shown in the embodiment of FIG. 4A), symbols, alpha-characters, and the like. The invention is not so limited.

As one of ordinary skill in the art will understand upon reading this disclosure, various embodiments of the present invention offer a user an added level of flexibility for image to mat template association. By way of illustration and not by way of limitation, the embodiment of FIG. 4A allows a user to associate a one or more images, e.g. 402-1, . . . , 402-N, with one or more templates, e.g. 410, 420, 430, and 440. As shown in the embodiment of FIG. 4A, this can be achieved using the plurality of mat template identifiers, e.g. 411, 421, 431, and 441 (A, B, C, and D as shown in the embodiment of FIG. 4A). Thus, in the embodiment of FIG. 4A, a single template, e.g. 410, can be selected from the group 410, 420, 430, and 440, and one or more images, e.g. 402-1, . . . , 402-N, can be associated therewith, as the same has been described in detail in connection with the above Figures.

Likewise, several templates can be selected from the group 410, 420, 430, and 440, and can be populated with selected images, e.g. 402-1, . . . , 402-N. The embodiment of FIG. 4A can be used to illustrate the same. Thus, as shown in the embodiment of FIG. 4A, by way of example and not by way of limitation, image 402-1 includes an association identifier 403-1 including a several numbered bubbles. As described in detail above, the invention is not limited to this particular type of association identifier. In the embodiment of FIG. 4A, a bubble numbered 1 has been marked to associate image 402-1 with one or more position identifiers, e.g. 413-1, 423-1, 433-1, and 443-1 also having the number 1.

Likewise, as shown in the embodiment of FIG. 4A, by way of example and not by way of limitation, image 402-1 includes an image template identifier 404-1 including a several lettered bubbles. As one of ordinary skill in the art will appreciate upon reading this disclosure, embodiments of the present invention are not limited to the particular type of image template identifier. Indeed, it has been shown that various embodiments include line segments in place of association identifiers and image and/or mat template identifiers. Thus, one of ordinary skill in the art will appreciate upon reading this disclosure that line segments can be employed in embodiments of the invention that have multiple mat templates and one or more images on a single proof sheet. The same is shown in the embodiment of FIG. 4B.

In the embodiment of FIG. 4A, a lettered bubble A, among the image template identifiers 404-1 provided to image 402-1, has been marked to associate image 402-1 with mat template 410 having a mat template identifier similarly labeled with the letter A. Thus, in this example of the embodiments shown in FIG. 4A, image 402-1 is associated with image position 1, e.g. position identifier 413-1, for mat template 410.

As one of ordinary skill in the art will appreciate upon reading this disclosure, other association identifiers 403-1 and image template identifiers 404-1 can be marked in a similar or different fashion to additionally associate image 402-1 to other image positions on one or more different mat templates. That is, association identifier bubble labeled 2 among association identifiers 403-1 can be “checked” and lettered bubble C in image template identifier 404-1 can be similarly “checked” to associate image 402-1 with image position 2 for mat template 430. In various embodiments, an image, e.g. image 402-1, can have an association identifier, e.g. bubble 1, marked and also have several image template identifiers, e.g. bubbles A and C, marked. In this manner, image 402-1 can be associated with two or more image positions labeled 1, e.g. position identifiers 413-1 and 433-1, in two or more mat templates 410 and 430. Thus, in this example image 402-1 can be positioned in image positions 412-1 and 432-1 for mat templates 410 and 430.

One of ordinary skill in the art will appreciate the extent to which this process can continue. That is, by way of illustration and not by way of limitation, in the embodiment of FIG. 4A image 402-4 is shown associated with image position 2 on template A, image 402-N is shown associated with image position 3 on template A, image 402-2 is shown associated with image position 1 on template D, image 402-5 is shown associated with image position 2 on template D, and image 402-3 is shown associated with image position 3 on template D. Those skilled in the art will understand from reading the disclosure and practicing the invention that more sets of identifiers can be linked to the images if desired.

In various embodiments, one or more proof sheets can be created including one or more pieces of print media wherein the one or more images and one or more mat templates can be provided thereon. Those skilled in the art will appreciate upon reading this disclosure and practicing the invention that the one or more images and templates can be intermingled on one or more proof sheets (as described above) and that the images can be provided on one or more proof sheets and the templates can be provided on one or more different proof sheets (as described next).

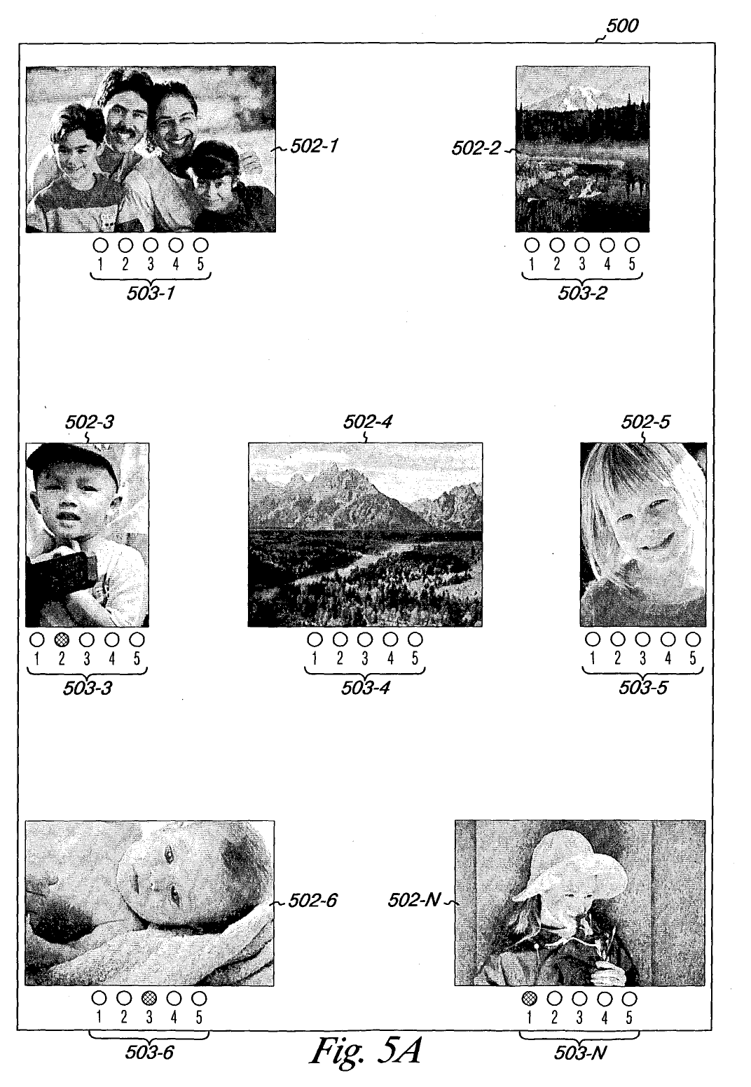

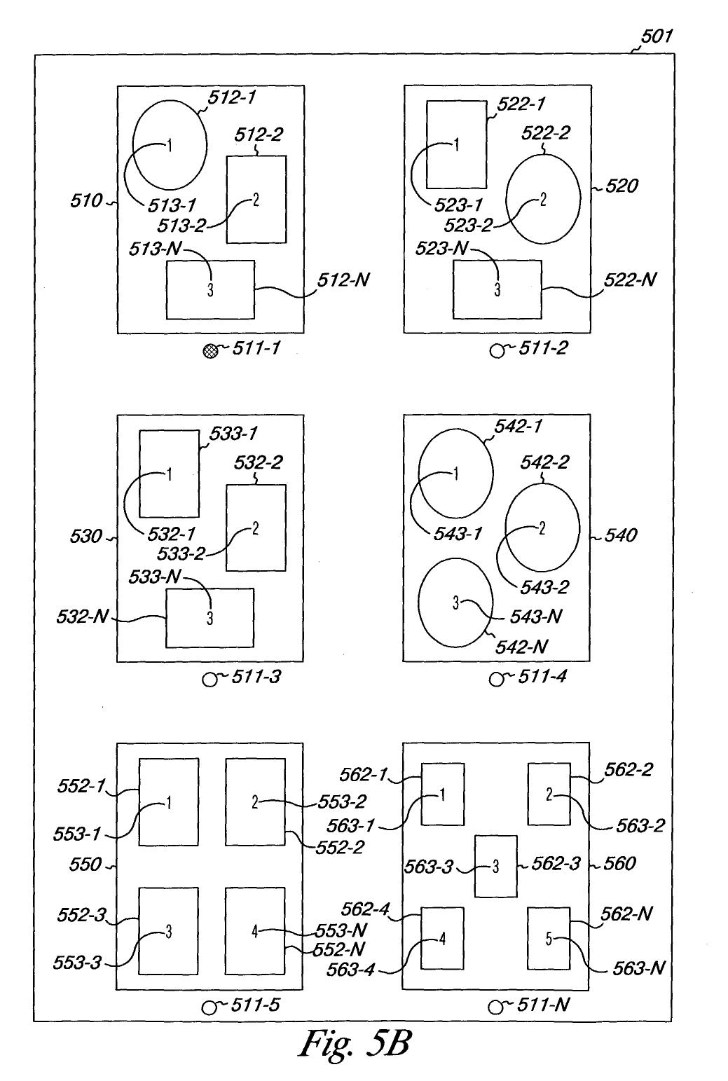

FIGS. 5A and 5B illustrate another embodiment for associating one or more images with one or mat templates according to the teachings of the present invention. In the embodiment of FIGS. 5A and 5B, FIG. 5A illustrates a proof sheet 500 having plurality of images 502-1, . . . , 502-N, as the same have been described in detail in connection with the above Figures. In the embodiment of FIG. 5A, each of the plurality of images 502-1, . . . , 502-N include association identifiers 503-1, . . . , 503-N, as the same have been described herein in connection with the above Figures. In the embodiment of FIG. 5A, the association identifiers 503-1, . . . , 503-N are illustrated as including a several numbered bubbles. As described in detail above, the invention is not limited to this particular type of association identifier. Further, in the embodiment of FIG. 5B, each of the association identifiers, 503-1, . . . , 503-N, include five association identifier choices. As one of ordinary skill in the art will appreciate upon reading this disclosure and as will be realized in reference to FIG. 5B, this will account for the number of image positions available on any given template. In the various embodiments of the present invention, enough association identifiers are be provided to achieve association with all of the position identifiers available for any selected template.

FIG. 5B illustrates a proof sheet 501 having a plurality of templates thereon, 510, 520, 530, 540, 550, and 560. As described in detail above, each of the plurality of templates, represented by mat template identifiers 511-1, 511-2, 511-3, 511-4, 511-5, 511-N, can include a plurality of image positions or openings of any shape or form as the same have been described in detail in connection with the above Figures. In the embodiment of FIG. 5B, the plurality of image positions or openings, of any shape or form, are illustrated as 512-1, . . . , 512-N, 522-1, . . . , 522-N, 532-1, . . . , 532-N, 542-1, . . . , 542-N, 552-1, . . . , 552-N, and 562-1, . . . , 562-N respectively. As one of ordinary skill in the art will appreciate upon reading this disclosure, each of the plurality of image positions or openings, 512-1, . . . , 512-N, 522-1, . . . , 522-N, 532-1, . . . , 532-N, 542-1, . . . , 542-N, 552-1, . . . , 552-N, and 562-1, . . . , 562-N, in each of the plurality of templates, 510, 520, 530, 540, 550, and 560, can include a plurality of position identifiers as the same have been described in detail herein. In the embodiment of FIG. 5B, the plurality of position identifiers are illustrated as 513-1, . . . , 513-N, 523-1, . . . , 523-N, 533-1, . . . , 533-N, 543-1, . . . , 543-N, 553-1, . . . , 553-N, and 563-1, . . . , 563-N respectively. Again, as one of ordinary skill in the art will appreciate upon reading this disclosure, the plurality of position identifiers, 513-1, . . . , 513-N, 523-1, . . . , 523-N, 533-1, . . . , 533-N, 543-1, . . . , 543-N, 553-1, . . . , 553-N, and 563-1, . . . , 563-N, can include numbers, (e.g. 1, 2, 3, 4, 5, etc. as shown in the embodiment of FIG. 5B), symbols, alpha-characters, and the like. The invention is not so limited.

As one of ordinary skill in the art will understand upon reading this disclosure, various embodiments of the present invention offer a user an added level of flexibility for image to mat template association. By way of illustration and not by way of limitation, the embodiment of FIG. 5B allows a user to associate a one or more images, e.g. 502-1, . . . , 502-N, with one or more templates, e.g. 510, 520, 530, 540, 550, and 560. As shown in the embodiment of FIG. 5B, a mat template is selectable by marking a respective mat template identifier 511-1, 511-2, 511-3, 511-4, 511-5 and 511-N. As with the other identifiers and marks disclosed herein, a mark made to any of the mat template identifiers, 511-1, 511-2, 511-3, 511-4, 511-5 and 511-N, can be any number of suitable marks. The invention is not so limited.

As one of ordinary skill in the art will appreciate upon reading this disclosure, a plurality of images 502-1 to 502-N can be provided on one or more first proof sheets, e.g. sheet 500 and a plurality of mat templates, 510, 520, 530, 540, 550, and 560, can be provided on one or more second proof sheets, or template sheets, e.g. sheet 501. Thus, in the various embodiments of the present invention, associations between the plurality of images 502-1 to 502-N and the plurality of mat templates, 510, 520, 530, 540, 550, and 560, can be created on separate or distinct sheets.

In the embodiment of FIGS. 5A and 5B a template 510 represented by mat template identifier 511-1 has been selected on sheet 501. By way of illustration and not by way of limitation, the mat template identifier 511-1 in the embodiment of FIG. 5B includes a shape, shown here as a circle or bubble, but not so limited thereto, and that shape has been marked by shading, however, the invention is not so limited. Accordingly, the images 502-1, . . . , 502-N and their association identifiers, 503-1, . . . , 503-N will be associated with this particular mat template 510. In the embodiment on sheet 500 in FIG. 5A, image 502-N has an association identifier 1, from among association identifiers 503-N, selected associating image 502-N to image position identifier 1, 513-1, on mat 510. Image 502-3 has an association identifier 2, from among association identifiers 503-3, selected associating image 502-3 to image position identifier 2, 513-2, on mat 510. And, image 502-6 has an association identifier 3, from among association identifiers 503-6, selected associating image 502-6 to image position identifier 3, 513-N, on mat 510.

As one of ordinary skill in the art will appreciate upon reading this disclosure, the separate or distinct sheets, e.g. first and second proof sheets, 500 and 501 having associations as described herein, can be scanned into a device. A device or system, such as have been described above, having software operable thereon according to the teachings of the present invention, can operate on the scanned data and position images to appropriate image positions for mat templates in accordance with the various association embodiments of the present invention.

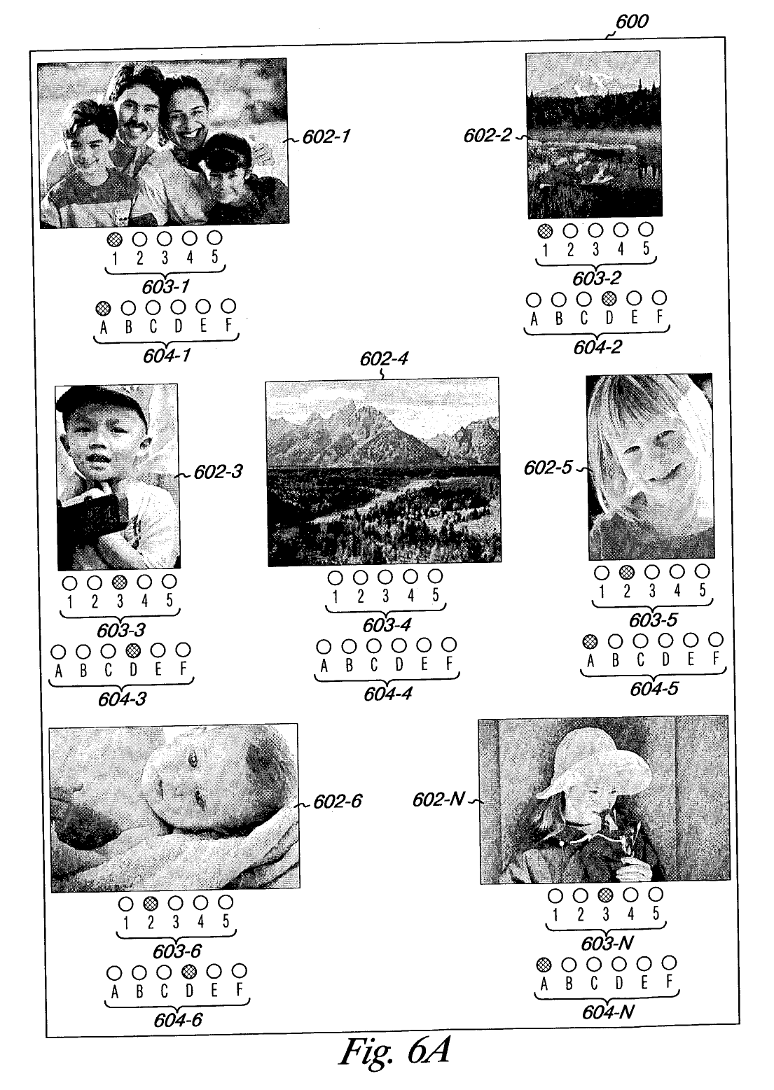

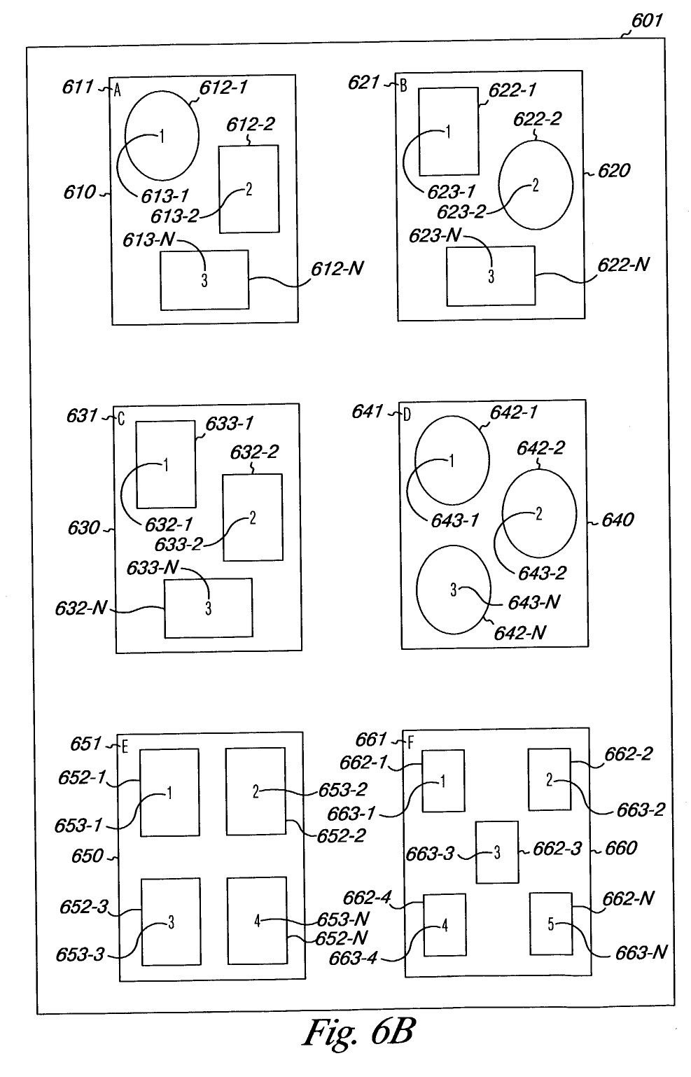

FIGS. 6A and 6B illustrate another embodiment using multiple proof sheets according to the teachings of the present invention. The embodiments of FIGS. 6A and 6B are a hybrid of FIG. 4A and FIGS. 5A and 5B.

In the embodiment of FIGS. 6A and 6B, FIG. 6A illustrates a proof sheet 600 having plurality of images 602-1, . . . , 602-N, as the same have been described in detail in connection with the above Figures. In the embodiment of FIG. 6A, each of the plurality of images 602-1, . . . , 602-N include association identifiers 603-1, . . . , 603-N, as the same have been described herein in connection with the above Figures. In the embodiment of FIG. 6A, the association identifiers 603-1, . . . , 603-N are illustrated as including a several numbered bubbles. As described in detail above, the invention is not limited to this particular type of association identifier. Further, in the embodiment of FIG. 6A, each of the association identifiers, 603-1, . . . , 603-N, include five association identifier choices. As explained above and as will be realized in reference to FIG. 6B, this will account for the number of image positions available on any given template. In the various embodiments of the present invention, enough association identifiers can be provided to achieve association with all of the available position identifiers for any given template.

In the embodiment of FIG. 6A, each of the plurality of images 602-1, . . . , 602-N further include a plurality of image template identifiers, illustrated as 604-1, . . . , 604-N. By way of example and not by way of limitation, the image template identifiers 604-1, . . . , 604-N for the plurality of images 602-1, . . . , 602-N, each include several lettered bubbles. As one of ordinary skill in the art will appreciate upon reading this disclosure, embodiments of the present invention are not limited to this particular type of image template identifier.

FIG. 6B illustrates a proof sheet 601 having a plurality of templates thereon, 610, 620, 630, 640, 650, and 660. In the embodiment of FIG. 6B, each of the plurality of templates, 610, 620, 630, 640, 650, and 660, is provided with a mat template identifier, e.g. 611, 621, 631, 641, 651, and 661 respectively. As one of ordinary skill in the art will understand upon reading this disclosure, the mat template identifiers, 611, 621, 631, 641, 651, and 661 can include numbers, symbols, alpha-characters, e.g. A, B, C, D, E, and F as shown in the embodiment of FIG. 6B, and the like. Any form of identifier which can distinguish the plurality of templates, 610, 620, 630, 640, 650, and 660 is considered within the scope of the present invention.

As described in detail above, each of the plurality of templates, 610, 620, 630, 640, 650, and 660 can include a plurality of image positions or openings of any shape or form as the same have been described in detail in connection with the above Figures. In the embodiment of FIG. 6B, the plurality of image positions or openings, of any shape or form, are illustrated as 612-1, . . . , 612-N, 622-1, . . . , 622-N, 632-1, . . . , 632-N, 642-1, . . . , 642-N, 652-1, . . . , 652-N, and 662-1, . . . , 662-N respectively.

As one of ordinary skill in the art will appreciate upon reading this disclosure, each of the plurality of image positions or openings, 612-1, . . . , 612-N, 622-1, . . . , 622-N, 632-1, . . . , 632-N, 642-1, . . . , 642-N, 652-1, . . . , 652-N, and 662-1, . . . , 662-N, in each of the plurality of templates, 610, 620, 630, 640, 650, and 660, can include a plurality of position identifiers as the same have been described in detail herein. In the embodiment of FIG. 6B, the plurality of position identifiers are illustrated as 613-1, . . . , 613-N, 623-1, . . . , 623-N, 633-1, . . . , 633-N, 643-1, . . . , 643-N, 653-1, . . . , 653-N, and 663-1, . . . , 663-N respectively. Again, as one of ordinary skill in the art will appreciate upon reading this disclosure, the plurality of position identifiers, 613-1, . . . , 613-N, 623-1, . . . , 623-N, 633-1, . . . , 633-N, 643-1, . . . , 643-N, 653-1, . . . , 653-N, and 663-1, . . . , 663-N, can include numbers, (e.g. 1, 2, 3, 4, 5, etc. as shown in the embodiment of FIG. 6B), symbols, alpha-characters, and the like. The invention is not so limited.

As one of ordinary skill in the art will understand upon reading this disclosure, various embodiments of the present invention offer a user an added level of flexibility for image to mat template association. By way of illustration and not by way of limitation, the embodiment of FIG. 6B allows a user to associate a one or more images, e.g. 602-1, . . . , 602-N (located on one or more first proof sheets 600) with one or more templates, 610, 620, 630, 640, 650, and 660 (located on one or more second proof sheets, or template sheets 601).

As shown in the embodiment of FIG. 6B, this can be achieved using the plurality of mat template identifiers, e.g. 611, 621, 631, 641, 651, and 661 (A, B, C, D, E, and F as shown in the embodiment of FIG. 6B). Thus, in the embodiment of FIG. 6B, a single template, e.g. 610, can be selected from the group of available mat templates 610, 620, 630, 640, 650, and 660 and one or more images, e.g. 602-1, . . . , 602-N, can be associated therewith, as the same has been described in detail in connection with the above Figures. Likewise, several templates can be selected from the group 610, 620, 630, 640, 650, and 660, and can be populated with selected images, e.g. 602-1, . . . , 602-N. The embodiments of FIGS. 6A and 6B can be used to illustrate the same.

As shown in the embodiments of FIGS. 6A and 6B, by way of example and not by way of limitation, image 602-1 (on sheet 600) includes an association identifier 603-1 including a several numbered bubbles. As described in detail above, the invention is not limited to this particular type of association identifier. In the embodiment of FIG. 6A, a bubble numbered 1, among the association identifiers 603-1, has been marked to associate image 602-1 with one or more position identifiers, e.g. 613-1, 623-1, 633-1, 643-1, 653-1, and 663-1 also having the number 1.

Likewise, as shown in the embodiment of FIG. 6A, by way of example and not by way of limitation, image 602-1 includes an image template identifier 604-1 including a several lettered bubbles. As one of ordinary skill in the art will appreciate upon reading this disclosure, embodiments of the present invention are not limited to the particular type of image template identifier.

In the embodiment of FIG. 6A, a lettered bubble A, among the image template identifiers 604-1 provided to image 602-1, has been marked to associate image 602-1 with mat template 610 (on sheet 601) having a mat template identifier 611-1 similarly labeled with the letter A. Thus, in this example of the embodiments shown in FIG. 6A, image 602-1 is associated with image position 1, e.g. position identifier 613-1, for mat template 610.

As one of ordinary skill in the art will appreciate upon reading this disclosure, other association identifiers 603-1 and image template identifiers 604-1 can be marked in a similar or different fashion to additionally associate image 602-1 to other image positions on one or more different mat templates. That is, association identifier bubble labeled 2 among association identifiers 603-1 can be “checked” and lettered bubble C in image template identifier 604-1 can be similarly “checked” to associate image 602-1 with image position 2 for mat template 630.

In various embodiments, an image, e.g. image 602-1 can have an association identifier marked, e.g. bubble 1, and also have several image template identifiers marked, e.g. bubbles A and C. In this manner, image 602-1 can be associated with several image positions labeled 1, e.g. position identifiers 613-1 and 633-1, for mat templates 610 and 630. Thus, in this example, image 602-1 can be positioned in image positions 612-1 and 632-1 for mat templates 610 and 630.

One of ordinary skill in the art will appreciate the extent to which this process can continue. That is, by way of illustration and not by way of limitation, in the embodiment of FIG. 6A image 602-5 (on sheet 600) is shown associated with image position 2 on template A, e.g. template 610 (on sheet 601), image 602-N (on sheet 600) is shown associated with image position 3 on template A (on sheet 601), image 602-2 (on sheet 600) is shown associated with image position 1 on template D, e.g. template 640 (on sheet 601), image 602-6 (on sheet 600) is shown associated with image position 2 on template D (on sheet 601), and image 602-3 (on sheet 600) is shown associated with image position 3 on template D (on sheet 601). Those skilled in the art will understand from reading the disclosure and practicing the invention that more sets of identifiers can be linked to the images if desired.

Again, as one of ordinary skill in the art will appreciate upon reading this disclosure, the separate or distinct sheets, e.g. first and second proof sheets, 600 and 601 having associations as described herein, can be scanned into a device. A device or system, such as have been described above, having software operable thereon according to the teachings of the present invention, can operate on the scanned data and position images to appropriate image positions in accordance with the various association embodiments of the present invention.

Those skilled in the art will appreciate upon reading this disclosure and practicing the invention, that prints of the images can be made on a local printing device 102 or 210, for example, onto print media such as paper or any other such suitable print media. It can also be appreciated that images can be sent to a remote printing device, such as an internet-based picture service through an Internet or other network connection, such as that shown at 120 of FIG. 1.

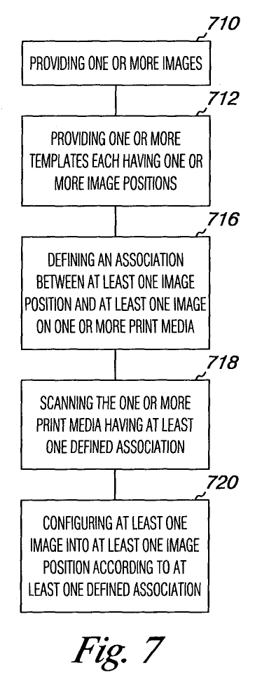

FIGS. 7-9 are block diagrams illustrating various method embodiments of the invention. As one of ordinary skill in the art will understand, the methods can be performed by software, application modules, and computer executable instructions operable on the systems and devices shown herein or otherwise. Such software, application modules, and/or computer executable instructions can be resident in one location or in several and even many locations, such as in a distributed computing environment, throughout a system as described above. The invention, however, is not limited to any particular operating environment or to software written in a particular programming language. Unless explicitly stated, the methods described below are not constrained to a particular order or sequence. Additionally, some of the so described methods can occur or be performed at the same point in time.

FIG. 7 is a block diagram illustrating a method according to an embodiment of the present invention. In the embodiment of FIG. 7, a method for positioning images is provided. The method includes providing one or more images as indicated at block 710. The method also includes providing one or more templates each having one or more image positions at block 712.

The method also includes defining an association between at least one image position and at least one image on one or more print media at block 716. In some embodiments, defining an association between at least one image position includes assigning each image position a position identifier and labeling an image with a corresponding identifier. In various embodiments, assigning each image position a position identifier includes assigning a position identifier which is a number. In various embodiments, defining an association between at least one image position includes constructing a line extending between an image position and an image. In some embodiments, providing one or more images can include providing each image with a plurality of bubbles (e.g. ovals) therewith and associating at least one bubble with each image position. In some embodiments, defining an association between at least one image position and at least one image on one or more print media includes forming an association between an image position and an image by marking in a bubble of an image to be associated with the image position.

As shown in the embodiment of FIG. 7, the method also includes scanning the one or more print media having at least one defined association as indicated at block 718. The method further includes configuring at least one image into at least one image position according to at least one defined association at block 720.

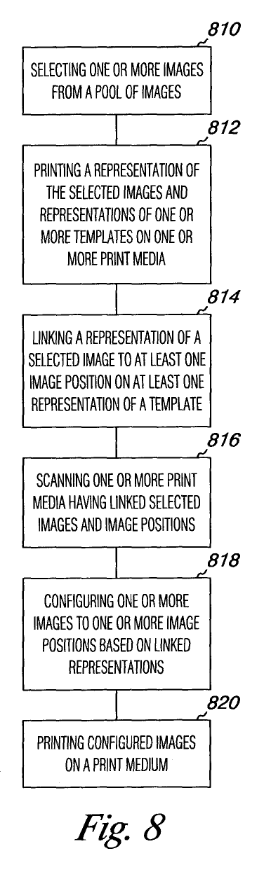

FIG. 8 is a block diagram illustrating a method according to an embodiment of the present invention. In embodiment of FIG. 8, a method for creating a print medium having one or more images thereon is provided. The method includes selecting one or more images from a pool of images as indicated at block 810.

In the embodiment of FIG. 8, the method also includes printing a representation of the selected images and representations of one or more templates on one or more print media at block 812. A representation of an image can be the image itself a small version of the image (e.g. thumbnail), or any other suitable representation of the image. In some embodiments, printing a representation of the selected images and representations of one or more templates on one or more print media includes printing one or more images and one or more templates on a single print medium. In some embodiments, printing representations of one or more templates on one or more print media includes printing representations of one or more templates selected from the group of, a universal template pool, one or more scanned templates, and/or one or more templates accessed over a network in reference to a list of manufacturer template reference numbers.

In the embodiment of FIG. 8, the method further includes linking a representation of a selected image to at least one image position on at least one representation of a template at block 814. The method also includes scanning one or more print media having linked selected images and image positions at block 816.

In the embodiment of FIG. 8, the method also includes configuring one or more images to one or more image positions based on linked representations at block 818. In some embodiments, configuring one or more images to one or more image positions based on linked representations includes rotating one or more of the selected images by using a mark associated with an image representation. In various embodiments, configuring one or more images to one or more image positions based on linked representations includes scaling the image to fit the image position by using a mark associated with an image representation. In various embodiments, configuring one or more images to one or more image positions based on linked representations includes cropping an image to fit an image position. In some embodiments, at least one image position has a defined size and wherein cropping the image is accomplished by selecting a portion of a representation of a selected image that corresponds to the defined size. In some embodiments, selecting a portion of a representation of a selected image includes defining at least a part of the selected portion with a mark.

In the embodiment of FIG. 8, the method further includes printing configured images on a print medium at block 820.

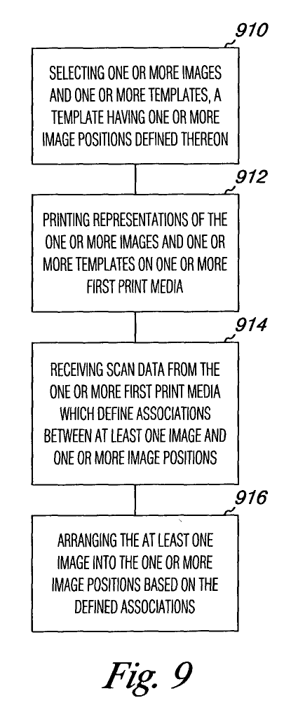

FIG. 9 is a block diagram illustrating a method according to an embodiment of the present invention. In the embodiment of FIG. 9, the method includes selecting one or more images and one or more templates, a template having one or more image positions defined thereon as indicated at block 910. The method also includes printing representations of the one or more images and one or more templates on one or more first print media at block 912. In various embodiments, printing representations of the one or more images and one or more templates on one or more first print media includes printing the one or more images on a first proof sheet and printing the one or more templates on a second proof sheet. The method further includes, receiving scan data from the one or more first print media which define associations between at least one image and one or more image positions at block 914. The method also includes arranging the at least one image into the one or more image positions based on the defined associations at block 916. In some embodiments, the method can further include printing the arranged one or more images on a second print medium.

The invention has been described in detail with particular reference to one or more embodiments thereof. However, it will be appreciated that variations and modifications can be effected by a person of ordinary skill in the art without departing from the spirit and scope of the invention. Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of the various embodiments of the invention. It is to be understood that the above description has been made in an illustrative fashion, and not a restrictive one. Combination of the above embodiments, and other embodiments not specifically described herein will be apparent to those of skill in the art upon reviewing the above description. The scope of the various embodiments of the invention includes any other applications in which the above structures and methods are used. Therefore, the scope of various embodiments of the invention should be determined with reference to the appended claims, along with the full range of equivalents to which such claims are entitled.

It is emphasized that the Abstract is provided to comply with 37 C.F.R. § 1.72(b), requiring an Abstract that will allow the reader to quickly ascertain the nature of the technical disclosure. It is submitted with the understanding that it will not be used to limit the scope of the claims.

In the foregoing Detailed Description, various features are grouped together in a single embodiment for the purpose of streamlining the disclosure. This method of disclosure in not to be interpreted as reflecting an intention that the embodiments of the invention require more features than are expressly recited in each claim. Rather, as the following claims reflect, inventive subject matter can reside in less or fewer than all features of a single disclosed embodiment. Thus, the following claims are hereby incorporated into the Detailed Description, with each claim standing on its own as a separate embodiment.

What is claimed:

1. A method for positioning images, comprising:
providing one or more images;
providing one or more templates each having one or more image positions;
defining an association between at least one image position and at least one image on one or more print media;
scanning the one or more print media having at least one defined association; and
configuring at least one image into at least one image position according to at least one defined association.

2. The method of claim 1, wherein defining an association between at least one image position includes assigning each image position a position identifier and labeling an image with a corresponding identifier.

3. The method of claim 2, wherein assigning each image position a position identifier includes assigning a position identifier which is a number.

4. The method of claim 1, wherein defining an association between at least one image position includes constructing a line extending between an image position and an image.

5. The method of claim 1, wherein providing one or more images includes providing each image with a plurality of bubbles therewith and associating at least one bubble with each image position.

6. The method of claim 5, wherein defining an association between at least one image position and at least one image on one or more print media includes forming an association between an image position and an image by marking a bubble of an image to be associated with the image position.

7. A method for creating a print medium having one or more images configured thereon, comprising:
selecting one or more images from a pool of images;
printing a representation of the selected images and representations of one or more templates on one or more print media;
linking a representation of a selected image to at least one image position on at least one representation of a template;
scanning one or more print media having linked selected images and image positions;
configuring one or more images to one or more image positions based on linked representations; and
printing configured images on a print medium.

8. The method of claim 7, wherein printing representations of the selected images and representations of one or more templates includes printing one or more images and one or more templates on a single print medium.

9. The method of claim 7, wherein printing a representation of the selected images and representations of one or more templates on one or more print media includes printing representations of one or more templates selected from the group of; a universal template pool, a scanned template, and a list of manufacturer templates.

10. The method of claim 7, wherein configuring one or more images to one or more image positions based on linked representations includes rotating one or more of the selected images by using a mark associated with an image representation.

11. The method of claim 7, wherein configuring one or more images to one or more image positions based on linked representations includes scaling an image to fit an image position by using a mark associated with an image representation.

12. The method of claim 7, wherein configuring one or more images to one or more image positions based on linked representations includes cropping an image to fit an image position.

13. The method of claim 12, wherein at least one image position has a defined size and wherein cropping the image is accomplished by selecting a portion of a representation of a selected image that corresponds to the defined size.

14. The method of claim 13, wherein selecting a portion of a representation of a selected image includes defining at least a part of the selected portion with a mark.

15. A device readable medium, comprising:
one or more template representations having one or more image positions;
one or more image representations;
one or more position identifiers corresponding to one or more image positions; and
one or more association identifiers corresponding to the one or more image representations.

16. The medium of claim 15, wherein the device readable medium is a proof sheet.

17. The medium of claim 15, wherein the one or more position identifiers include one or more symbols.

18. The medium of claim 15, wherein the one or more position identifiers include one or more colors.

19. The medium of claim 15, wherein the one or more position identifiers include one or more shaped objects.

20. The medium of claim 15, wherein the medium includes an association between one or more position identifiers and one or more association identifiers.

21. The medium of claim 20, wherein the association includes a line connecting at least one position identifier and at least one association identifier.

22. The medium of claim 15, wherein each image representation includes one or more predefined association identifiers which corresponds to at least one predefined position identifier of at least one image position.

23. The medium of claim 22, wherein the association identifier that corresponds to a position identifier is selectable from one or more association identifiers.

24. The medium of claim 23, wherein each image representation includes at least one mark that corresponds to an image and wherein the mark provides a formatting instruction.

25. A system, comprising:
a scanning component for scanning a print medium;
a printing component operably coupled to the scanning component; and
software means operable on the system for receiving scan data from the print medium, having defined associations between at least one image and one or more image positions, and operable for arranging at least one image into the one or more image positions based on the defined associations.

26. The system of claim 25, wherein the scanning device is operable for receiving scan data of a mat for creating a mat template therefrom.

27. The system of claim 25, wherein the system further includes a memory operable to store one or more images.

28. The system of claim 27, wherein the memory includes memory operable to store one or more mat templates.

29. The system of claim 28, wherein the memory is provided on a removable memory source.

30. The system of claim 25, wherein the scanning component and the printing component are included in a single electronic device.

31. A device readable medium having instructions thereon for causing a device to perform a method, comprising:
selecting one or more images and one or more templates, a template having one or more image positions defined thereon;
printing representations of the one or more images and one or more templates on one or more first print media;
receiving scan data from the one or more first print media which define associations between at least one image and one or more image positions; and
arranging the at least one image into the one or more image positions based on the defined associations.

32. The device readable medium of claim 31, wherein the method further includes printing the arranged one or more images on a second print medium.

33. The device readable medium of claim 31, wherein printing representations of the one or more images and one or more templates on one or more first print media includes printing the one or more images on a first proof sheet and the one or more templates on a second proof sheet.

34. A device, comprising;
a print mechanism operable to print a proof sheet;
a scanning mechanism operable to receive scan data from a proof sheet including at least one association between an image and an image position of a template; and
wherein the device is operable to interpret the scan data and operable to arrange an image to an associated image position.
